(19) United States
(12) Patent Application Publication
(10) Pub. No.: US 2016/0321946 A1
(43) Pub. Date: Nov. 3, 2016

(54) FACILITATING HABIT FORMATION THROUGH USE OF MOBILE DEVICES

(71) Applicant: Habit Design, Inc., Bellevue, WA (US)

(72) Inventor: Michael Kim, Bellevue, WA (US)

(73) Assignee: Habit Design, Inc,, Bellevue, WA (US)

(21) Appl. No.: 15/143,134

(22) Filed: Apr. 29, 2016

Related U.S. Application Data
(60) Provisional application No. 62/154,686, filed on Apr. 29, 2015.

(51) Int. Cl. G09B 19/00; G09B 5/02

(52) U.S. Cl. CPC G09B 19/00; G09B 5/02

(57) ABSTRACT

The disclosure relates to a computer-implemented method for facilitating formation of a new habit through use of a client device. A user may designate via a Habit Design Application on the client device or a networked peripheral a desired Habit step, Trigger step, Anchor step, and Anchor condition. Upon detection of an occurrence of the Anchor step, the Habit Design Application may provide a reminder to the new user to perform the Trigger step and Habit step in response to at least the occurrence of the Anchor step. When a user is designating a habit design sequence, a Habit Design Service Provider networked to the Habit Design Application may utilize machine learning techniques over a data storage to determine from crowdsourced data the optimal Habit steps, habit design sequences, or habit design steps associated with the fastest onset of previous users' self-reported automaticity for the Habit step.

### CROSS REFERENCE TO RELATED PATENT APPLICATION

This application claims priority to U.S. Provisional Patent Application No. 62/154,686, filed on Apr. 29, 2015, entitled “Method and Apparatus for Habit Learning,” which is hereby incorporated by reference in its entirety.

### BACKGROUND

Human beings are creatures of habit. They respond to cues in their environment and are prone to responding to subconscious urges. They tend towards both conscious and unconscious patterning, and often follow a sequence of automatic routines.

Generally, there is a three-step loop when performing habits. First, a cue triggers the brain to switch to performance of a routine. This cue may become deeply ingrained with each repetition of the habit. Then there is the routine that is performed in response to the cue. Finally, there is a reward, which reinforces the performance of the routine upon receiving the cue.

The habitual performance of such automatic routines allows people to be productive, while relieving them of cognitive stress that present when they are performing tasks that require their close attention. Thus, the formation of new and beneficial habits can greatly aid an individual's productivity and reduce their stress.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a context diagram for facilitating habit-learning through use of client devices.

FIG. 2 illustrates schematic diagrams of an example client device and an example Habit Design server for facilitating formation of new habits.

FIG. 3 is a flow diagram of an illustrative process for facilitating habit-learning through use of a client device.

FIG. 4 is a flow diagram of an illustrative process for surfacing crowdsourced recommendations for a habit design step by utilizing machine learning techniques.

FIGS. 5A through 5C illustrate a series of example user interfaces that may be displayed to a user to enable the user to begin creating a new habit to learn after initiating a software application for facilitating habit-learning on a client device.

FIGS. 6A through 6H illustrate a series of example user interfaces that may be displayed to a user to enable the user to designate a Habit step, designate an Anchor step to precede the Habit step, designate a Trigger step to immediately follow the preceding Anchor step, and designate a desired time of day to receive a reminder to perform the Trigger step and Habit step after the Anchor step has occurred.

FIGS. 7A through 7K illustrate a series of example user interfaces that may be displayed to a user to enable the user to design/create their habit design sequence, practice each step in a given habit design sequence in real-time at a pre-determined location, and track and compare their habit design sequence performance with other participants in the network.

FIG. 8 illustrates an example of a user interface that is displayed to a user to enable the user select virtual currency that can be used for activities within the application.

FIGS. 9A through 9C illustrate a series of example user interfaces that may be displayed to a user to enable the user to find, to invite friends to use the mobile application, and to select whether to follow (or unfollow) friends who also use the mobile application.

### DETAILED DESCRIPTION

The disclosure is directed in part to techniques for facilitating formation of a new habit through use of a client device. The techniques may include use of a non-transitory computer-readable storage medium storing a computer program that, when executed, causes a computing system in a client device to perform a method for facilitating the formation of a new habit.

As used herein, a “client device” includes any device capable of accepting input of information, displaying information, or manipulating information in an analog electronic form or in digital electronic form. A client device may thus include any computing device, such as but not limited to a personal computer, a smart phone, tablet, laptop computer. As used herein, a client device may or may not be connected to a network.

In embodiments where the client device is connected to a network, one or more of the steps of the method as described herein may be performed on a networked peripheral accessed by the client device through the network. A networked peripheral may be a device communicatively coupled to the client device via the network, such as but not limited to a remote computer, wearable computing device, Bluetooth headset, iBeacon sensor, Smart Home sensor, or voice-controlled device. As will be readily understood by those having ordinary skill in the art, in embodiments where the client device is connected to a network and any of the steps of the method described herein are performed on a networked peripheral and the results of those steps are then communicated from the networked peripheral to the client device are the functional equivalent of performing those steps in the client device and/or the computing system in the client device. As such, any steps described herein that are performed on a networked peripheral that is connected to the client device are therefore included within the definition of performing such steps on a client device or a computing system in a client device, as those terms are used herein.

In some embodiments, a software application (“Habit Design Application”) may be configured to display a user interface upon the client device or a networked peripheral to facilitate a user's gradual learning of a desired new habit. The user may designate via the user interface a habit design sequence, which may be comprised of habit design steps relating to facilitating learning the new habit.

In some embodiments, habit design steps designated by the user may include (1) a “Habit” step, which may be the desired action of the new habit, such as “Run just 1 block”); (2) an “Anchor” step, which may relate to a pre-existing habitual behavior the user already experiences in their everyday life (e.g., “After I get dressed . . . ”); (3) a “Trigger” step, which may be a small behavior that immediately follows the Anchor step and facilitates the Habit step (e.g., by making it easier to perform); and (4) an “Anchor” condition(s), the detection of which may relate to the occurrence of the Anchor step. Accordingly, a useful Trigger step may be an action that is easy to perform immediately after the Anchor step and that facilitates the Habit step by making the Habit step easier to perform (e.g., “Put on my running shoes”).

The step of designating a new Habit step may be performed by selecting a Habit step from a group of pre-existing Habit steps displayed by the client device or a networked peripheral. The group of pre-existing Habit steps may be organized into groups, which herein are termed “Habit Packs,” that may be loaded into the user's client device or networked peripheral. These Habit Packs may consist of groups of habits organized by various factors that are relevant to a user. For example, and not meant to be limiting, a group of Habit steps in a Habit Pack may relate to Habit steps that are any one of the following: common in topic/category (e.g., “Exercise”); common to a user's organization or job; common to a user's friends, family or coworkers; common to a user's location; commonly performed by others with behavioral similarities to the user; commonly performed by others with similar profiles to a user; commonly performed by others with social connections to a user; or commonly reported by other users on a network connected to a user's client device or networked peripheral (e.g., habits that are trending or popular on a network).

The client device or networked peripheral may be configured to provide a reminder to the user to perform the Trigger step and the Habit step in response to the occurrence of the Anchor step. For example, and not meant to be limiting, if a user normally gets dressed at 8:00 AM, the user may designate as an Anchor condition a “reminder time” of 8:00 AM, set by the user to receive a reminder to practice a Trigger step of “put on running shoes” followed by a Habit step of “run just 1 block” after an Anchor step of “After I get dressed.”

The reminder may be provided via the user interface, in response to the detection of the Anchor condition. In some embodiments, an Anchor condition may be based on data provided by the client device or a networked peripheral, such as but not limited to a time, a date, a location of the computing device, an orientation of the computing device, a rate of motion of the computing device, or a direction of motion of the computing device, proximity to other users or resources that may assist the user in the successful practice of their designated habit design sequence. Further, a reminder provided to the user by the Habit Design Application may be configured to be at least one of the following: a notification message or image displayed on the user interface of the client device or a networked peripheral, vibrating the client device or networked peripheral, or emitting from the client device or networked peripheral a sound, such as but not limited to a ringtone, an alarm, or a recorded voice message.

In various embodiments, the sequence of habit design steps may be presented as a connecting chain of images when the user is creating, changing, editing, analyzing, sharing, tracking, or performing a new Habit step within the Habit Design Application or other user interfaces through which the Habit Design Application, in part or total, may be presented (e.g., email, Website, etc.). When designating a Habit step, Anchor step, or Trigger step in the sequence, the user may either a) enter customized text and/or image or b) select from a list of pre-existing options.

In some embodiments, the order in which the pre-existing Anchor, Trigger, and Habit step options are surfaced to the user interface may be determined by utilizing machine learning techniques to recommend selectable options based on crowdsourced habit performance data of previous users having profile and habit performance information within a predetermined range of the user's profile and/or habit performance information. Habit performance data may include data related to previous users' success (or failure) in performing specific combinations of these Anchor-Trigger-Habit steps, including but not limited to the associated performance data taken for each previous user to self-report that the habit had become an automatic behavior and other user-generated data (e.g., affective evaluations, speed of completion of the full habit design sequence following the designated Anchor step condition, etc.). For example, and not meant to be limiting, profile information may include information related to a user's performance, demographic, the user's participating cohort population, the user's location, the time of day that the habit design sequence is set to be performed (or has been successfully performed historically by the user), the user's social relationship with other users, and user's interaction with other users through the Habit Design Application or other connected Web services (e.g., Facebook) and networked peripherals.

In some embodiments, a Habit Design Application may be communicatively coupled to a Habit Design Service Provider via a network. The Habit Design Service Provider may include at least one server comprising a Habit Design Engine and a data storage for storing user profile information and habit design sequence performance information. The Habit Design Engine may be configured to utilize machine learning techniques over a data storage containing crowdsourced profile information and performance data to make recommendations in response to various user queries.

As will be readily understood by those having ordinary skill in the art, machine learning techniques implemented by the Habit Design Engine may include but not be limited to decision trees (including boosted decision trees), Bayesian classification, artificial neural networks, and other machine learning techniques, whether presently known or developed in the future. In some embodiments, the Habit Design Engine may implement machine learning algorithms that operate by building mathematical models from crowdsourced user data in order to make data-driven predictions, decisions, or recommendations expressed as outputs provided to the user.

Accordingly, machine learning techniques may allow the Habit Design Engine to provide to a user recommendations of the most effective Habit steps, Habit Packs, habit design sequences, or constituent steps within those habit design sequences based on others with similar profile and performance data information. In exemplary embodiments, a Habit Design Engine may be configured to implement machine learning techniques over a data storage to determine the element(s) of habit design sequence (e.g., Anchor step and/or Trigger step) correlated with the fastest onset of self-reported automaticity (i.e., the shortest average time taken by previous users with similar profile information reported having learned to consistently perform the habit design sequence).

In some embodiments, a designated Habit step may have a quantitative dosage, difficulty, or intensity. The Habit Design Application may use machine learning techniques to determine from crowdsourced data a recommended minimum viable dosage of a given Habit step for a given user profile. For example, and not meant to be limiting, for a user who would like to develop the new habit of running every morning, the Habit Design Application may determine that a Habit step of “running just one block” is the incremental prescribed dosage associated with the fastest onset of previous users' self-reported automaticity of the habit of running, based on the performance data of previous users with profile information similar to the user's profile information. The user may opt whether to increase this dosage by a pre-determined increment (set by the application's algorithms) upon reaching certain performance goals (e.g., after successfully practicing their current habit design sequence consistently for four out of five weekdays in a given week) or not.

Further, the Habit Design Application may be configured to alert a user in advance of probable obstacles, which may be predicted by the Habit Design Engine using machine learning techniques from cumulative affective assessments of associate users who previously practiced the same habit step or similar habit design sequence (e.g., “Look out! Tomorrow is Day 11, which many indicate required Grit to complete, so hang in there!”) or share other attributes based on their profile or performance data. An associate user or “associate” may be a Habit Design Application user having at least some profile information similar to the user's. Accordingly, as participation in the user's network grows (e.g., by participation of associates within the user's company or healthcare provider network), the user may be able to form habits faster and more effectively.

The Habit Design Application may include various features relating to interaction with other users of the Habit Design Application on other devices. For example, and not meant to be limiting, the Habit Design Application may enable the user to “follow” or be followed by a second user, who may be an associate user, networked participant, and/or affiliate using the Habit Design Application on another device. The second user may have related profile information such as but not limited to belonging to the same workplace organization, social relationship, practicing the same Habit step or similar habit design sequence, etc. By following a second user, the first user may be allowed to view, receive, and send messages regarding the associate's application-related activity.

In various embodiments, the Habit Design Application may be configured to do at least one of the following: allow the user to share a new habit design sequence, Habit Pack, or Habit Design sequence step with associates; provide a notification to the associates' client devices or networked peripherals (“associate devices/peripherals”) in response to the detection of a condition related to the user's Anchor step or Trigger step; allow the associate to send to the user a message in response to receiving a notification of a detected Anchor step or Trigger step; and provide a notification to the associate in response to the user's performance of their habit design sequence.

In some embodiments, data provided by the client device or a networked peripheral may relate to a geographic location sensed using the client device's (or networked peripheral's) GPS and/or networking (e.g., Wi-Fi, cell tower proximity, etc.) functionality. For example, and not meant to be limiting, a user who wants to practice a Habit step of “walking just 1 block” (i.e., the desired new habit step) upon arriving at home after work (i.e., the Anchor step) may designate a Trigger step of “leash my dog.” Accordingly, the user may enable GPS functionality on her client device or networked peripheral and may configure a Habit Design Application to surface a reminder to begin practicing her habit design sequence when her client device or networked peripheral has sensed via GPS that she has returned to her home address after work.

Further, the client device and/or a networked peripheral may be configured to support highly granular geo-fencing utilizing sensor-based information generated from RFID, iBeacon, or Bluetooth LE sensors. For example, and not meant to be limiting, the Habit Design Application may be configured to detect an iBeacon sensor installed upon an object or location when the user's client device (or networked peripheral) is within a certain distance of the sensor. Further, the detection of the sensor may be an Anchor step condition relating to the user's physical proximity associated with the anchor step or trigger step (e.g., “After I walk past my running shoes”). Upon detection of the sensor, the Habit Design Application may surface a message to the client device and/or a networked peripheral.

Alternatively or concurrently, the Habit Design Application may be configured to detect an Anchor step based on motion activity sensed by the client device (or networked peripheral), such as but not limited to when the client device or networked peripheral includes an inertial sensor such as but not limited to an accelerometer or gyroscope. For example, and not meant to be limiting, for the user who has designated an Anchor step of “After I leave the meeting room,” the Habit Design Application may be configured to surface (or prohibit, in the absence of such conditions) a reminder notification upon sensing a specified threshold of motion activity of the client device or networked peripheral taking place within a range of time (e.g., between 9 AM and 5 PM).

In various embodiments, the detection of an Anchor step (and the reminder to immediately perform the Trigger step and then minimum viable dosage of the Habit step) may be at least partially based on a notification received by the computing device from an external source, such as but not limited to an electronic device or a web-service, which may be a social networking provider, smart-home peripheral or network, or an “If-This-Then-That” (“IFTTT”) web-service, etc. The external source may be communicatively coupled to the client device (or the Habit Design Server) via a communications network such as but not limited to a cellular network, broadband network, or Wi-Fi network. For example, and not meant to be limiting, a user may configure the Habit Design Application to provide a reminder of a Trigger step and/or new habit when a web-service detects a designated Anchor step, such as but not limited to a user's coffee maker signaling that it has begun brewing, a motion detector detecting the user has entered the kitchen, etc.

In various embodiments, the external source may be an electronic device communicatively coupled to the client device, such as but not limited to a wearable device, networked device or peripheral, motion detector, etc. For example, and not meant to be limiting, a user may be wearing a heart-rate monitoring device that is paired via Bluetooth to the user's smart phone. The user may configure the Habit Design Application to remind the user to perform a Habit step (e.g., “take just 1 deep breath”) when the monitoring device has measured a pre-determined heart-rate level (i.e., the Anchor condition step) designated by the user (or third-party affiliate) to prompt the reminder. In this example, an appropriate Trigger step may be “Sit in a comfortable chair.” Furthermore, the Habit Design Application may surface a notification responsive to any of the following illustrative examples: the Habit Design Application's detection of an occurrence or future occurrence of an Anchor step; the user's confirmation/affirmation of a habit design step, such as when a user “checks in” to an Anchor step (e.g., by tapping on a user interface an icon, image, or button representing the Anchor step); or an associate's sending a message to the user (e.g., a “Cheer” message to encourage the user to perform the Habit step). The surfaced notification provided by the Habit Design Application to the user may include any of the following: display of a notification message or image on a user interface of the wearable or networked device/peripheral, vibrating of the wearable or networked device/peripheral, or emitting of a sound from the wearable or networked device/peripheral.

Upon viewing a surfaced notification, the user may open the Habit Design Application and initiate via the user interface the application's “Practice Mode,” in which the Habit Design Application may provide additional features relating facilitating the user's successful performance of the habit, such as but not limited to a user interface that (1) displays hints or motivational words and images; (2) allows a user to “check in” to each step in the designated habit design sequence as they perform them each in the real-world, (3) allows a user to capture a photograph with the client device's camera after successfully practicing a habit design sequence; or (4) allows a user to share via social media information related to the performance of a habit, such as but not limited to an affective assessment or a milestone related to consistent performance of the new habit.

In various embodiments, the Habit Design Application may be configured to collect habit performance data each time a user checks in to a habit design step. Additionally, upon check-in to a habit design step, the client device or a networked peripheral may additionally geo-tag (i.e., assign a geographic location measured by the client device or networked peripheral to) the check-in. Further, the Habit Design Application may allow the user to take a “victory” photo (e.g., which may include, but not be exclusively defined by, a self-portrait photo taken in real-time at the specific location where the user performed the steps of their habit design sequence) and share it with the user's associates, other networked participants or application affiliates, or social media accounts. In various embodiments, the Habit Design Application may be configured to geo-verify a victory photo (i.e., confirm that the location-based meta-data associated with the image file of the photo is within a pre-determined range of the geographic location of at least one geo-tagged habit design step check-in).

An affective assessment may be a user's evaluation of one attempt to practice a Habit step within the context of a habit design sequence at a pre-determined context (e.g., the time and location associated with the designated Anchor step). The Habit Design Application may prompt the user to select from a pre-existing selection of affective assessments, such as but not limited to the following examples: “Flow—I didn't even need a reminder today”; “Hazard—watch out for this one today”; “Eureka!—I found a secret to success”; “Grit—I had to power through it today”; “Needs work”—“My Anchor or Trigger is not working yet”; and “It's a Habit”—it comes naturally now every day,” which is indication that the user has learned to perform the desired new habit design sequence without necessarily requiring a message facilitated by the Habit Design Application (i.e., indication of the user's self-reported automaticity performing the habit design sequence).

In some embodiments, the user interface may provide at least one reward for the user's successful practicing of the habit activity. A reward may be an in-application incentive that may provide additional incentive to consistently practice habit design sequences through use of the Habit Design Application. For example, and not meant to be limiting, the Habit Design Application may be configured to provide a congratulatory message after receiving indication that a user has successfully performed each step of a habit design sequence, under certain conditions. Further, the Habit Design Application may be configured to display various visual representations of the user's progress related to the practice of their habit design sequence(s), which the application may allow the user to compare against her associates and share on a connected social media platform such as but not limited to Facebook, Instagram, Snapchat, Twitter, et al.

Additionally, the Habit Design Application may reward a user's successful performance of a Habit step by crediting the user with a virtual currency. Virtual currency may allow a user to access enhanced application features (e.g., the creation of additional habit design sequences), and in some cases may be redeemed for prizes or real currency. For example, and not meant to be limiting, the Habit Design Application may be configured to enable an employer of a user to compensate the user's habit design sequence performances with monetary rewards. Additionally, the Habit Design Application may be configured to incentivize certain behaviors more than others by offering, For example, and not meant to be limiting, twice as much virtual currency for walking with an associate as for walking alone. Additionally, this virtual currency may also serve as a form of lottery, whereby each denomination of earned virtual currency constitutes as a chance to win a large prize.

In some embodiments, the Habit Design Application may be configured to allow the user to increase the incremental dosage or intensity of the Habit step (e.g., by increasing a running distance from 1 block to 2 blocks) after a user's consistent successful performance of a Habit step (e.g., after at least four successful practice weekdays within a given week).

Conversely, the Habit Design Application may be configured to apply a pre-determined response upon receiving indication that the user has not successfully practiced a habit. Example responses may include a decrease of the user's virtual currency; surfacing a motivational image or notification; allowing the user and other participants or affiliates to share a message with other users of the Habit Design Application or via a social media account; and allowing the user to decrease the current intensity level of the Habit step (e.g., by decreasing the number of blocks to be walked in completing the habit design sequence).

In some embodiments, the Habit Design Application may allow associate-coaching and associate support before a user to perform a habit design sequence. For example, and not meant to be limiting, based upon the profile and performance data of the user, the Habit Design Application may initiate a message to be sent to an associate, group of associates, or other networked participants or affiliates. The Habit Design Application may provide to any or all of these parties a description of the user's designated habit design sequence and may allow the party or parties to send a message to the user in advance of, or in lieu of, the detected occurrence of the user's Anchor step, such as but not limited to a “like” or a supportive “cheer” message. For example, and not meant to be limiting, if a user has set as an Anchor condition a reminder time of 12:00 PM, the Habit Design Application may be configured to send at 11:55 AM a message to each of a group of associates following the user's habit to remind the group to send a “cheer” message to the user in support of her imminent pending habit design sequence.

Additionally, the Habit Design Application may prompt users and associates to share helpful advice with other participants based upon the classification and associated profile and performance attributes of other participants, including but not limited to their affective evaluations and habit design sequence performance history. Similarly, an associate may send a “bounce back” encouragement to the user when certain conditions may call for greater social support (e.g., after the user has missed practicing their designated habit design sequence one day). Additionally, this “bounce back” may provide virtual or monetary rewards to the user and the instigating associate (e.g., “Since you missed your practice yesterday, if you practice your habit design sequence correctly today, we will both earn double points and your streak count will be restored.”).

In various embodiments, the Habit Design Application may allow a user to do at least one of the following: view their own and/or their cohort's historical performance data relating to practicing a given habit design sequence, set of habit design sequences, groups of suggested Habit steps (“habit packs”), or any constituent elements thereof (e.g., Anchor steps, Trigger steps, geo-tagged locations, etc.); purchase virtual currency for the purposes of obtaining additional habit packs or application features or settings; and connect social media accounts for the purposes of finding known users of the Habit Design Application and inviting others to start using the Habit Design Application, as well as posting their Habit Design Application activity to these third-party affiliate Web services (e.g., Facebook News Feed).

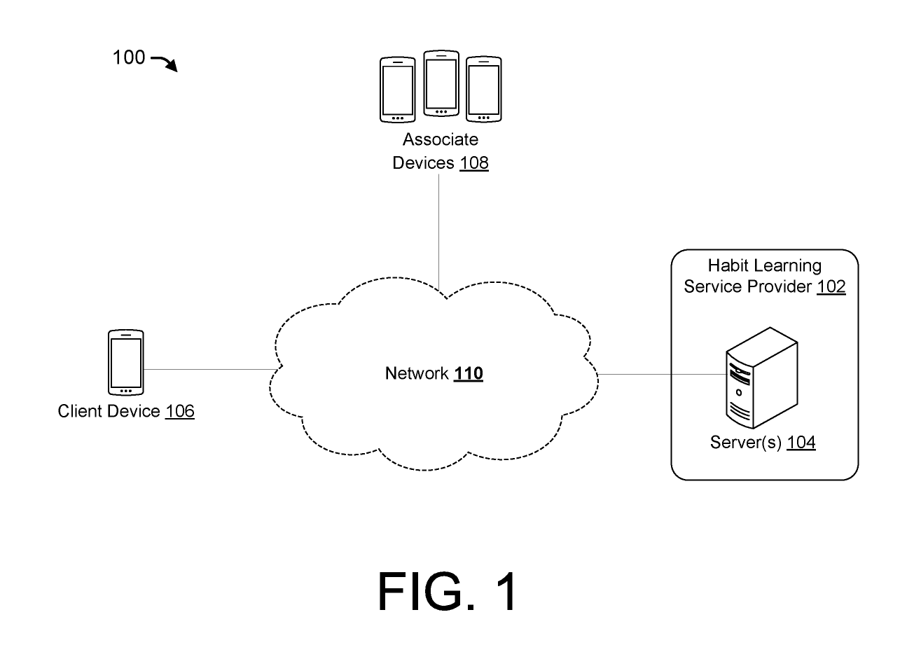

FIG. 1 is a context diagram 100 for facilitating the formation of habits through use of client devices. The computing environment may include a Habit Design Service Provider 102. The Habit Design Service Provider 102 may include servers 104 that interact with multiple client devices, such as but not limited to client device 106 and associate devices 108. Client device 106 may be a client device used by a person who is using a Habit Design Application on the client device for the purpose of developing a new habit. Associate devices 108 may be client devices used by associates of the user of client device 106. Associates may include followers of the user's activity on the Habit Design Application. In various embodiments, the servers 104 of the Habit Design Service Provider 102 may communicate with the client device 106 and the associate devices 108 via a network 110. The network 110 may be a local area network (“LAN”), a larger network such as but not limited to a wide area network (“WAN”), a mobile telephone network, and/or a collection of networks, such as but not limited to the Internet. The network 110 may be a wired network, a wireless network, or both.

Each of the client device 106 and the associate devices 108 may be a mobile communication device, a smart phone, a portable computer, a tablet computer, a slate computer, or any other electronic device that is equipped with network communication components to receive and transmit data, data processing components to process data, and user interface components to receive data from and present data to a user. Further, each of the client device 106 and the associate devices 108 may include some type of short range communication ability that is independent of on the network 110. In some embodiments, each of the client device 106 and the associate devices 108 may be equipped with NFC transceivers that enabled the devices to directly exchange data. In other embodiments, each of the client device 106 and the associate devices 108 may include components that enable the devices to exchange data via a Bluetooth link, a Wi-Fi connection, light-based communication (e.g., infrared data transfer) and/or acoustic-based data transfer.

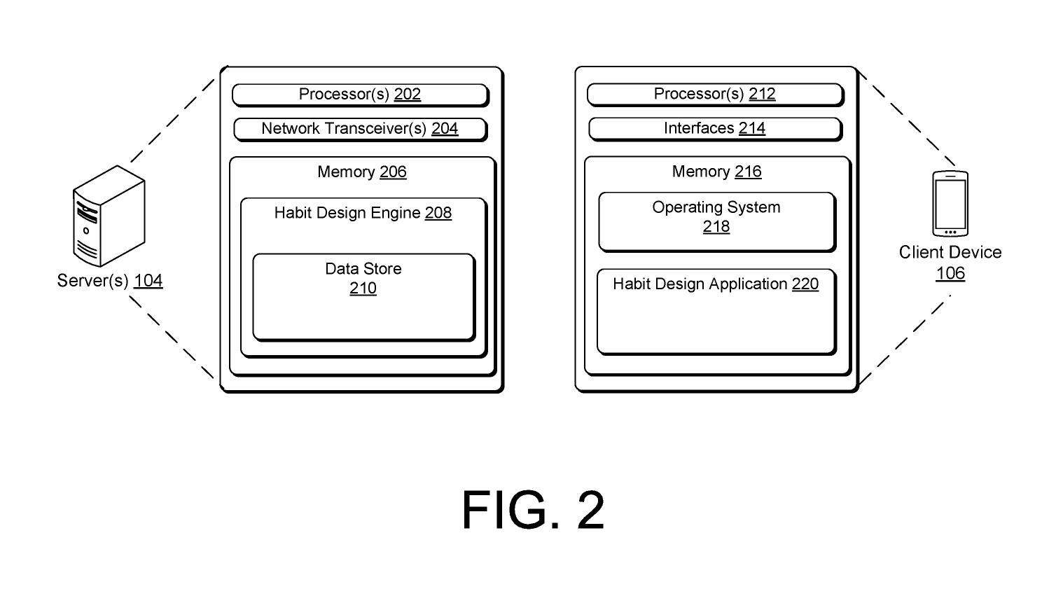

FIG. 2 illustrates schematic diagrams of an example client device and an example Habit Design server for facilitating formation of new habits.

The servers 104 may include processor(s) 202, network transceiver(s) 204, and a memory 206, which may comprise a Habit Design Engine 208 and a data storage 210. The network transceiver(s) 206 may include wireless and/or wired communication components that enable the servers 104 to transmit data to and receive data from other servers and devices via the network 110.

The memory 206 may include computer readable media. Computer readable media may include volatile and non-volatile, removable and non-removable media implemented in any method or technology for storage of information such as but not limited to computer readable instructions, data structures, program modules, or other data. As defined herein, computer readable media does not include communication media in the form of modulated data signals, such as but not limited to carrier waves, or other transmission mechanisms.

The data store 210 may store data that is received and processed by the Habit Design Engine 208. The data store 210 may store customer accounts, a transaction database, profile data, and habit performance data. The data store 210 may further store data and intermediate products such as but not limited to Habit Packs.

Client device 106 may include one or more processors 212, one or interfaces 214, and a memory 216, which may comprise an operating system 218 and a Habit Design Application 220. Interfaces 214 may include a network interface, a user interface, and at least one sensor interface. Accordingly, the client device 106 may include a sensor such as a camera, one or more accelerometers. Additionally, client device 106 may include a global positioning system (GPS) receiver. The memory 216 may include computer readable media. Computer readable media may include volatile and non-volatile, removable and non-removable media implemented in any method or technology for storage of information such as but not limited to computer readable instructions, data structures, program modules, or other data. As defined herein, computer readable media does not include communication media in the form of modulated data signals, such as but not limited to carrier waves, or other transmission mechanisms.

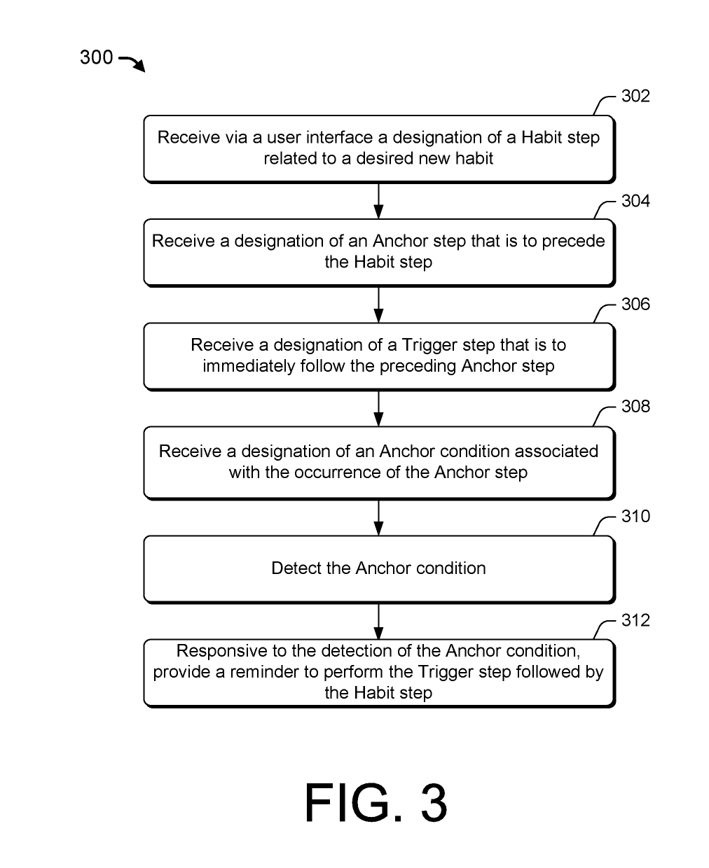

FIG. 3 is a flow diagram of an illustrative process 300 for facilitating habit-learning through use of Habit Design Application 220. At block 302, the Habit Design Application 220 may receive via a user interface a designation of a Habit step related to a desired new habit.

At block 304, the Habit Design Application 220 may receive via a user interface a designation of an Anchor step to precede the Habit step.

At block 306, the Habit Design Application 220 may receive via the user interface a designation of a Trigger step that is to immediately follow the Anchor step.

At block 308, the Habit Design Application 220 may receive a designation of an Anchor condition associated with the occurrence of the Anchor step.

At block 310, the Habit Design Application 220 may detect the Anchor condition.

At block 312, the Habit Design Application 220 may provide a surfaced notification to remind the user to perform the Trigger step followed by the Habit step.

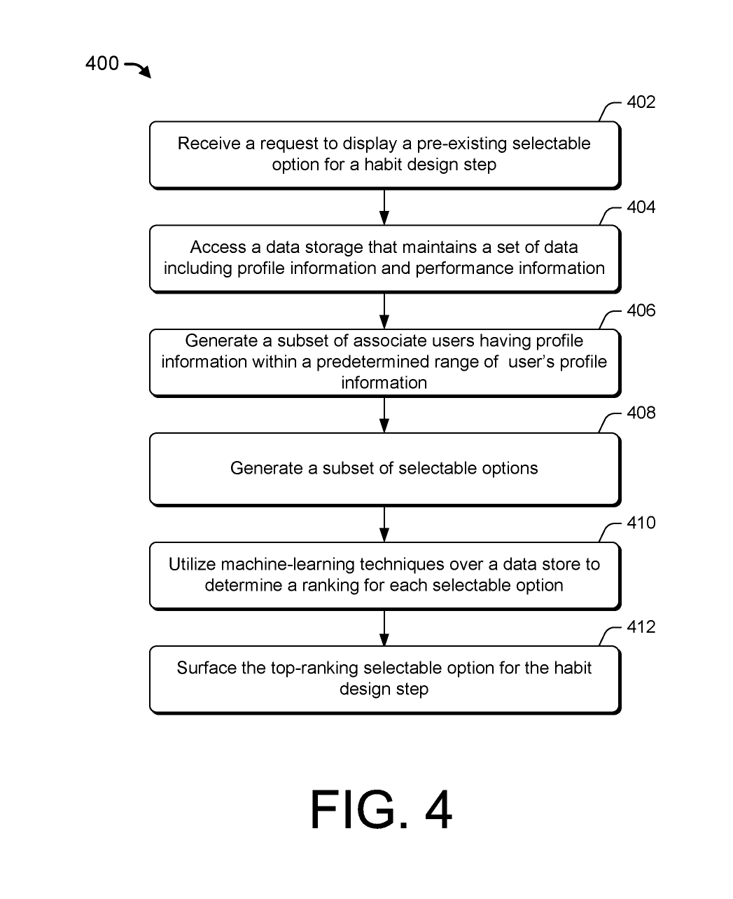

FIG. 4 is a flow diagram of an illustrative process 400 for surfacing crowdsourced recommendations for a habit design step by utilizing machine learning techniques. At block 402, the Habit Design Engine 208 may receive a request to display a pre-existing selectable option for a habit design step.

At block 404, the Habit Design Engine 208 may access Data Store 210 that maintains a set of data including profile information and performance information.

At block 406, the Habit Design Engine 208 may generate a subset of associate users having profile information within a predetermined range of the user's profile information.

At block 408, the Habit Design Engine 208 may generate a subset of selectable options relating to the habit design step.

At block 410, the Habit Design Engine 208 may utilize machine learning techniques over the data store to determine a ranking for each selectable options.

At block 412, the Habit Design Engine 208 may surface via the user interface the top-ranking selectable option for the habit design step.

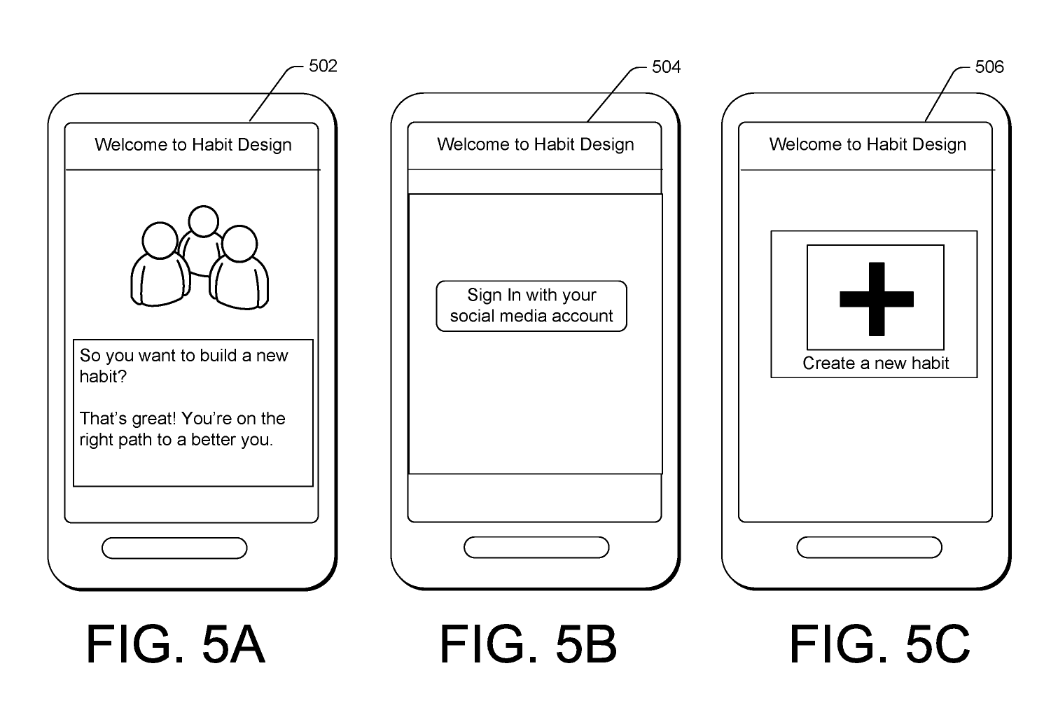

FIGS. 5A through 5C illustrate a series of example user interfaces that may be displayed upon client device 106 to enable the user to begin creating a new habit design sequence after initiating the Habit Design Application 220.

FIG. 5A shows an illustrative user interface page 502 displayed upon a user's initial use of the Habit Design Application 220.

FIG. 5B shows an illustrative user interface page 504 that enables the user to initiate signing into a social media account.

FIG. 5C shows an illustrative user interface page 506 that enables the user to initiate creation of a new habit design sequence.

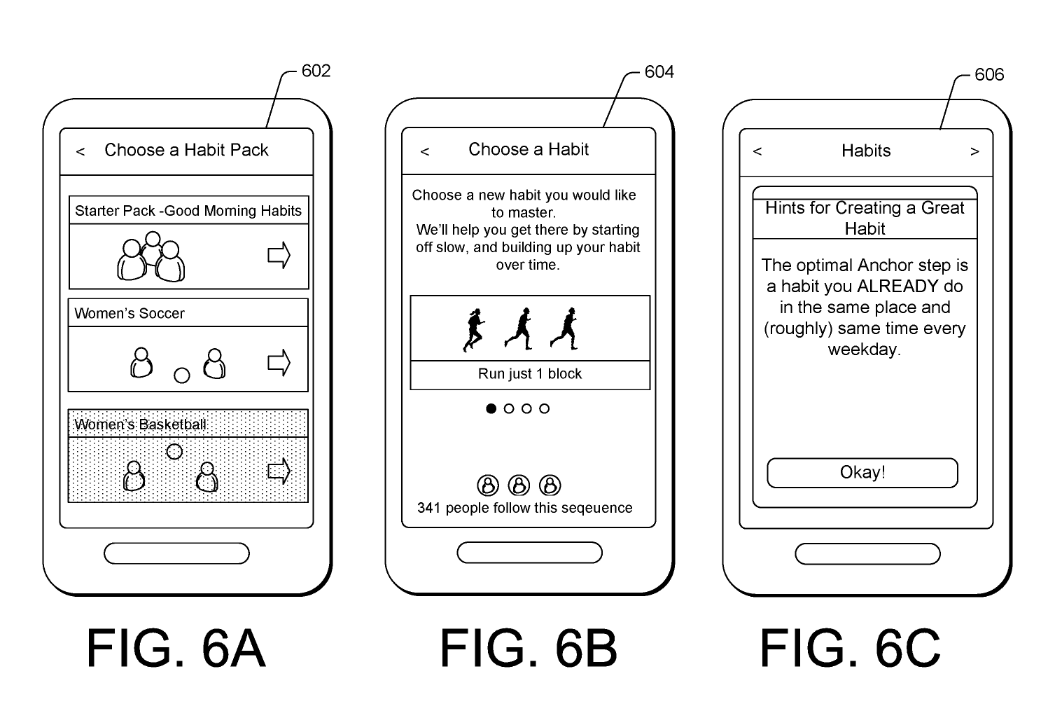

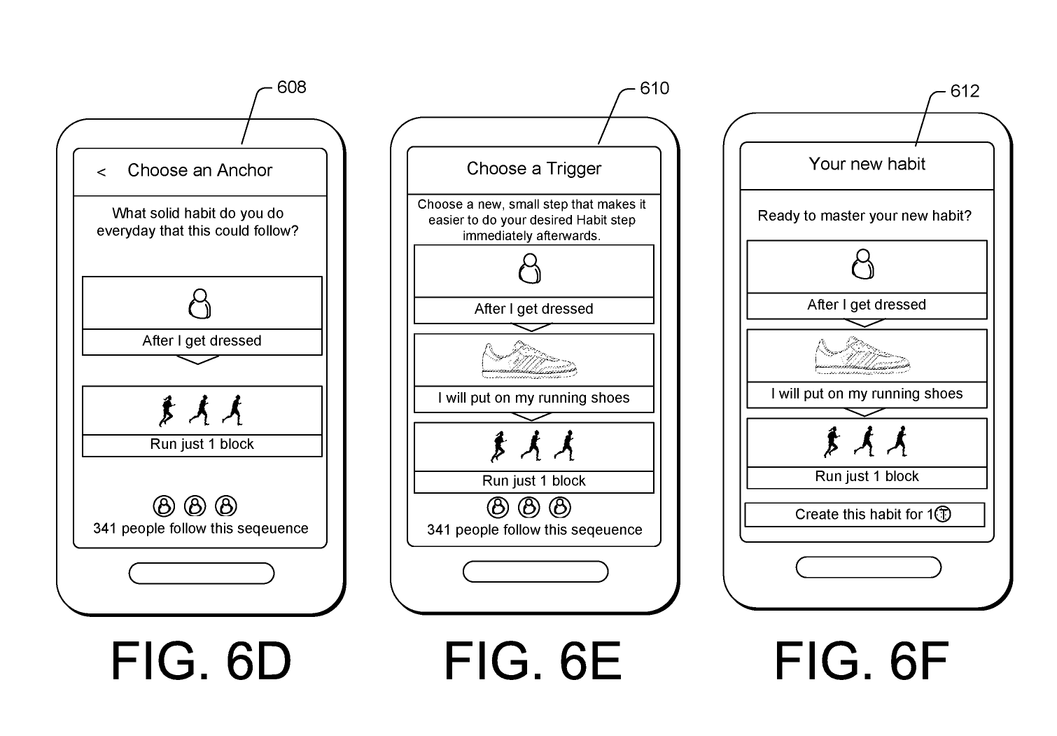

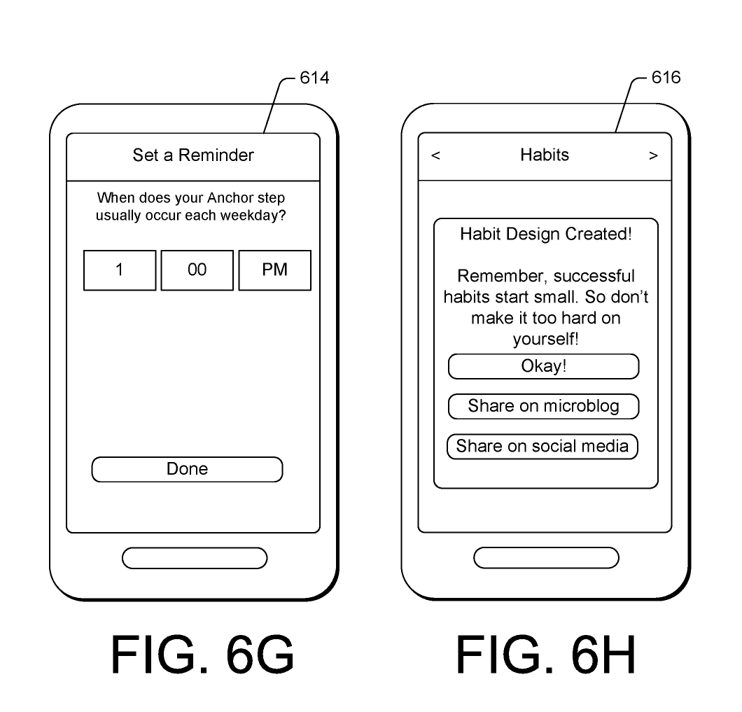

FIGS. 6A through 6H illustrate a series of example user interfaces that may be displayed upon client device 220 to enable the user to designate a desired Habit step, designate an Anchor step to precede the Habit step, designate a Trigger step to immediately follow the Anchor step and immediately precede the Habit step, and designate a desired time of day (i.e., the Anchor condition) to receive a reminder to perform the Trigger and Habit.

FIG. 6A shows an illustrative user interface page 602 that enables a user to select from a pre-existing list of Habit Packs. In some embodiments, the surfacing of the Habit Packs may be determined at least in part by the Habit Design Engine 208 utilizing machine learning techniques upon Data Store 210 containing crowdsourced associate user data.

The user may select either the “Starter Pack—Good Morning Habits” Habit Pack; the “Women's Soccer” Habit Pack; or the “Women's Basketball” Habit Pack. In various embodiments, the user may interact with the user interface (e.g., swipe an icon or photo) to examine other selectable Habit Pack options.

FIG. 6B shows an illustrative user interface page 604 that enables a user to choose from a list of pre-existing Habit steps available within the “Starter Pack—Good Morning Habits” Habit Pack. In some embodiments, the surfacing of the Habit step may be determined at least in part by the Habit Design Engine 208 utilizing machine learning techniques upon Data Store 210 containing crowdsourced associate user data. In various embodiments, the user may interact with the user interface (e.g., swipe an icon or photo) to examine other selectable Habit step options.

FIG. 6C shows an illustrative user interface page 606 that displays a hint to help the user strategically select an Anchor step.

FIG. 6D shows an illustrative user interface page 608 that enables user to choose an Anchor step for the designated Habit step (i.e., “Run just 1 block”). In some embodiments, the surfacing of the Anchor step may be determined at least in part by the Habit Design Engine 208 utilizing machine learning techniques upon Data Store 210 containing crowdsourced associate user data. In various embodiments, the user may interact with the user interface (e.g., swipe an icon or photo) to examine other selectable Anchor step options.

FIG. 6E shows an illustrative user interface page 610 that enables a user to choose a Trigger step to immediately follow the designated Anchor step (i.e., “After I Get Dressed”). In some embodiments, the surfacing of the Trigger step may be determined at least in part by the Habit Design Engine 208 utilizing machine learning techniques upon Data Store 210 containing crowdsourced associate user data. In various embodiments, the user may interact with the user interface (e.g., swipe an icon or photo) to examine other selectable Trigger step options.

FIG. 6F shows an illustrative user interface page 612 that enables a user to create a habit design sequence with the selected Anchor step, Trigger step (i.e., “I will put on my running shoes”), and Habit step, by tapping “Create this habit for 1T,” wherein “T” represents a “token.” In some embodiments, the Habit Design Application 220 may deduct from the user's virtual currency to create the habit. In various embodiments, the value of the deduction of virtual currency may vary according the factors such as but not limited to difficulty, popularity among associate users, or time of day.

FIG. 6G shows an illustrative user interface page 614 that enables the user to set a reminder time (i.e., the Anchor condition) corresponding to the time the user would like to practice the habit design sequence, starting with the Anchor step.

FIG. 6H shows an illustrative user interface page 616 that displays a message confirming the creation of a new habit design sequence and enables the user to share the creation of the habit design sequence on a microblog or social media platform.

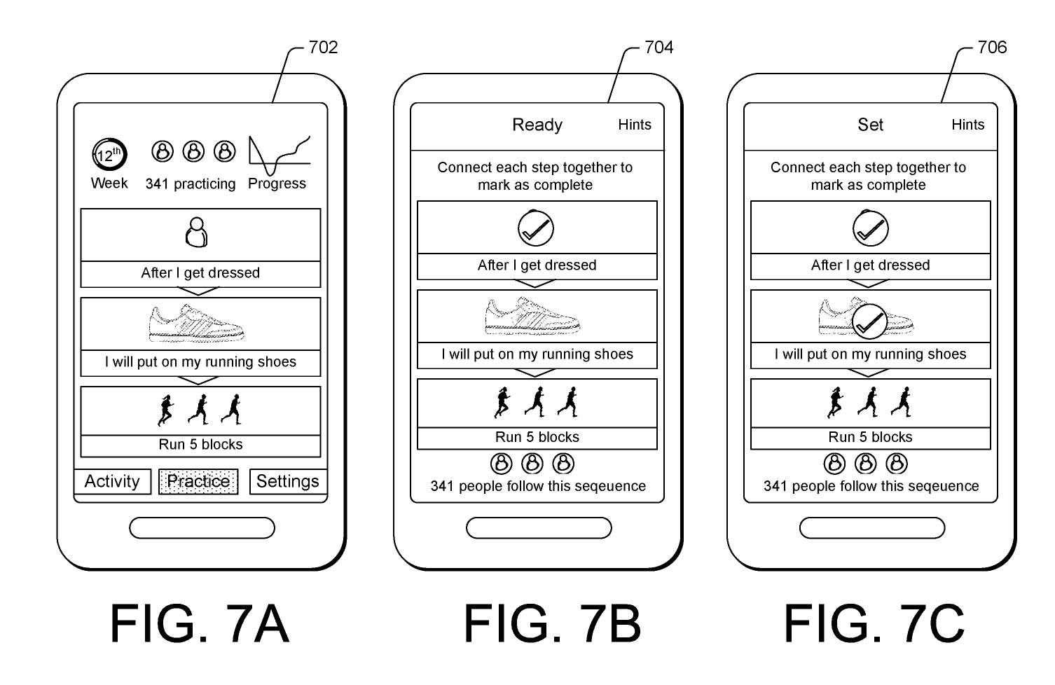

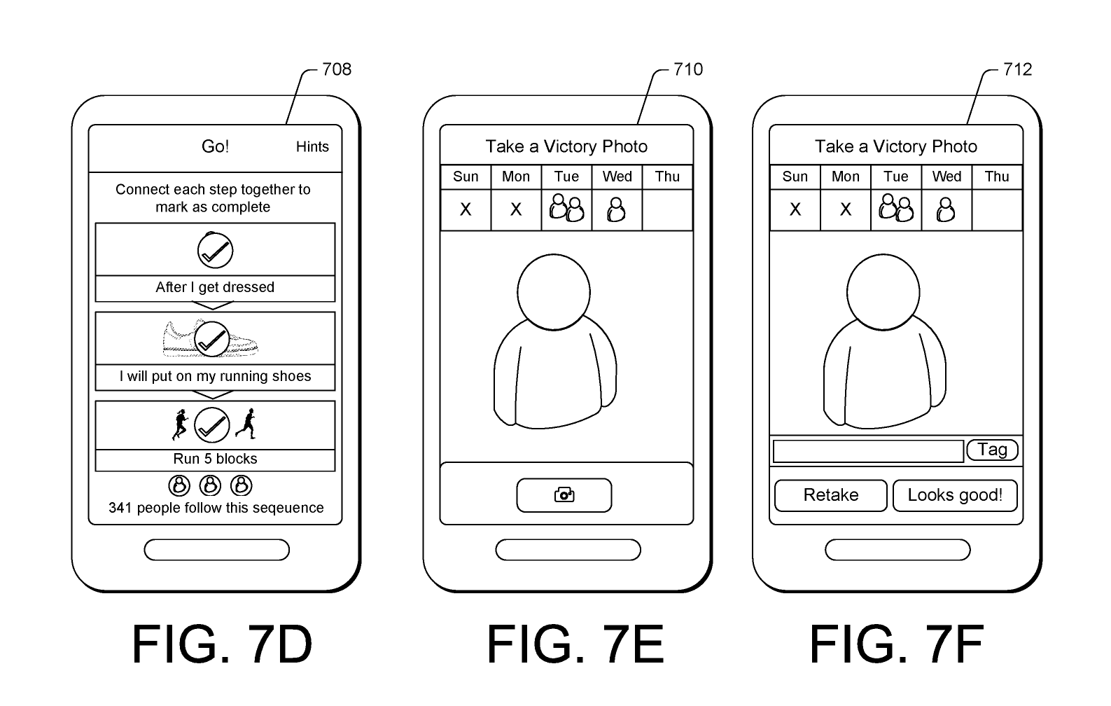

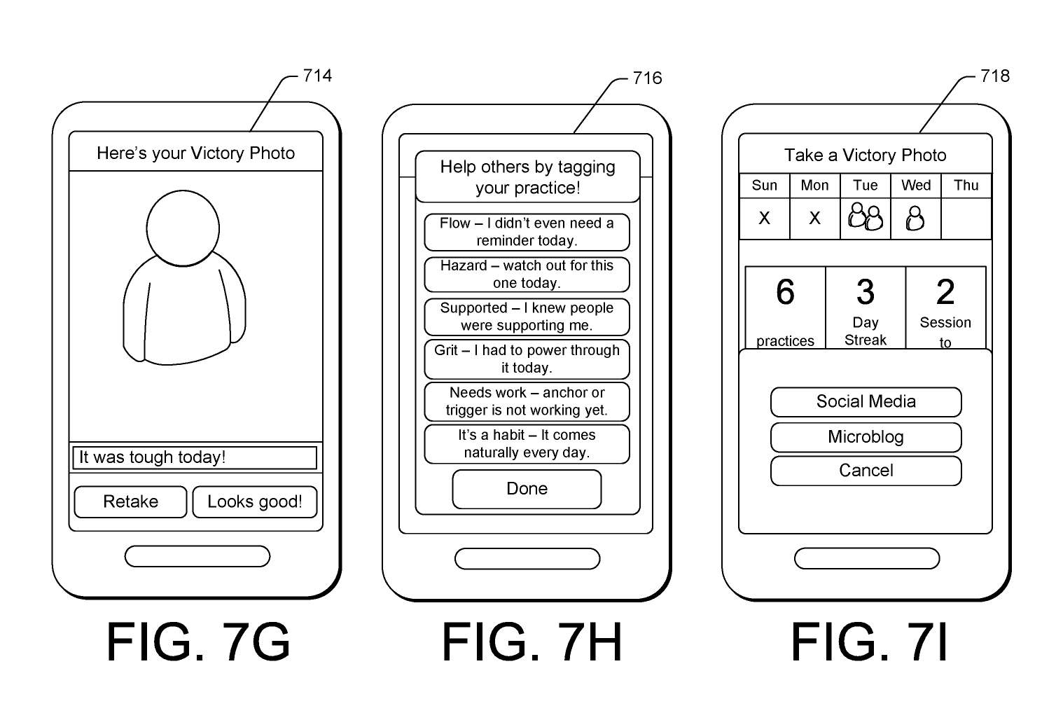

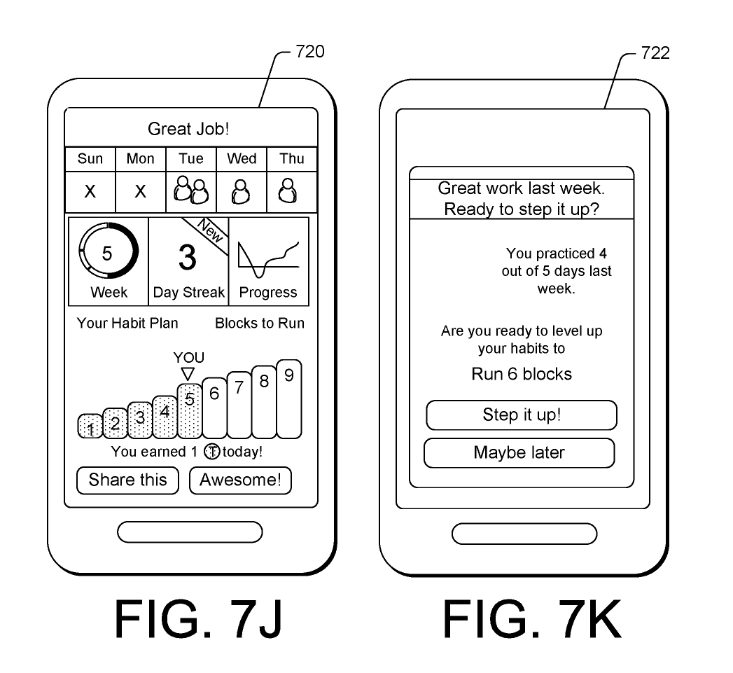

FIGS. 7A through 7K illustrate a series of example user interfaces that may be displayed to a user to enable the user to check into, track and share with followers their successful performance of habit design sequence.

FIG. 7A shows an illustrative user interface page 702 that displays a habit design sequence to be practiced by the user.

FIG. 7B shows an illustrative user interface page 704 that enables a user to check in to the Anchor step by tapping on the photo associated with the Anchor step.

FIG. 7C shows an illustrative user interface page 706 that enables a user to check in to the Trigger step by tapping on the photo associated with the Trigger step.

FIG. 7D shows an illustrative user interface page 708 that enables a user to check in to the Habit step by tapping on the photo associated with the Habit step.

FIG. 7E shows an illustrative user interface page 710 that enables the user to take a Victory photo.

FIG. 7F shows an illustrative user interface page 712 that enables the user to retake a Victory photo.

FIG. 7G shows an illustrative user interface page 714 that displays the Victory photo taken by user.

FIG. 7H shows an illustrative user interface page 716 that enables the user to tag the user's practicing of the habit design sequence.

FIG. 7I shows an illustrative user interface page 718 that enables the user to share the user's Victory photo and tag via a social media or microblog platform.

FIG. 7J shows an illustrative user interface page 720 that displays visualization of data related to the user's recent practicing of the habit design sequence and enables the user to share data via a social media or microblog platform.

FIG. 7K shows an illustrative user interface page 722 that enables the user to increase the dosage of the Habit step.

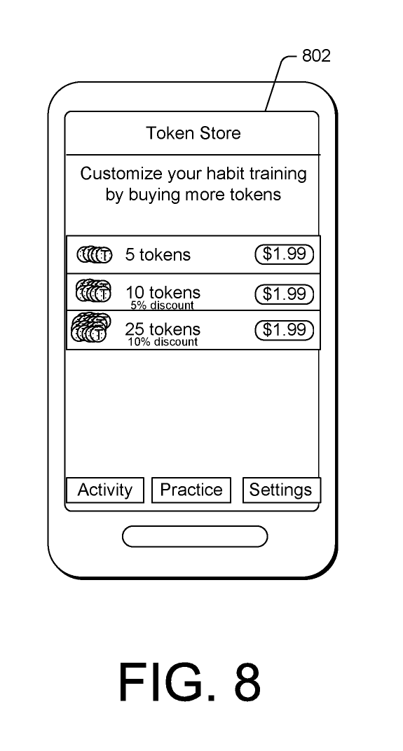

FIG. 8 illustrates an example of a user interface that is displayed to a user to enable the user select virtual currency that can be used for activities within the application.

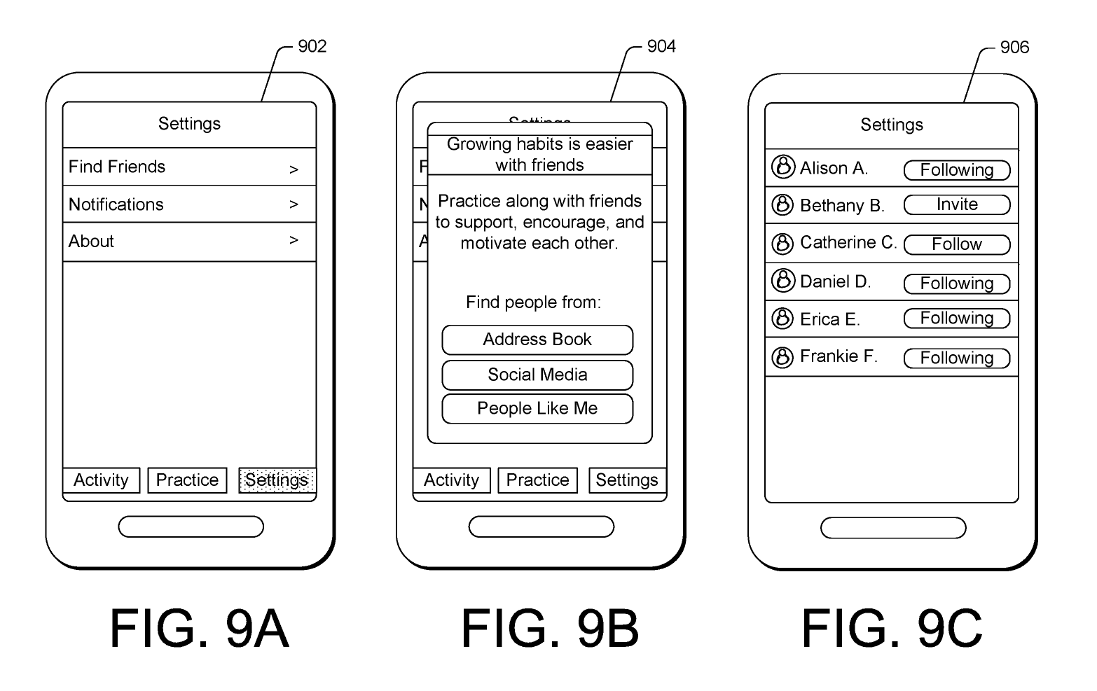

FIGS. 9A through 9C illustrate a series of example user interfaces that may be displayed to a user to enable the user to find, to invite friends to use the mobile application, and to select whether to follow friends who also use the mobile application.

FIG. 9A shows an illustrative user interface page 902 that enables the user to choose from a set of Habit Design Application settings categories.

FIG. 9B shows an illustrative user interface page 904 that enables the user to find or invite people to use the Habit Design Application using contacts in the user's address book, connections in social media, or associates who are already using the Habit Design Application and have profile information within a predetermined range of the user's profile information.

FIG. 9C shows an illustrative user interface page 906 that enables the user to invite or follow associate users connected to the user in the Habit Design Application.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A computer-implemented method for facilitating formation of a new habit, comprising:
receiving a designation of a Habit step that is associated with the new habit, the designation of the Habit step being inputted by a user via a user interface of a computing device;
receiving a designation of an Anchor step that is to precede the Habit step, the designation of the Anchor step being inputted by the user via the user interface of the computing device;
receiving a designation of an Anchor step condition, wherein the detection of the Anchor step condition indicates the occurrence of the Anchor step;
detecting the Anchor step condition based at least on data provided by the computing device; and
in response to at least the detecting of the Anchor step condition, providing via the user interface of the computing device a reminder to perform the Habit step.

2. The computer-implemented method of claim 1, wherein at least one of the Habit step and the Anchor step is selected from a plurality of pre-existing options, the plurality of pre-existing options determined based at least partially on data relating to a plurality of associate users, wherein:
the user has profile information related to the user; and
each of the plurality of associate users has related profile information within a predetermined range of the profile information related to the user.

3. The computer-implemented method of claim 2, wherein profile information includes information related to at least one of the user's demographic, the user's participating cohort population, the user's location, the time of day, or the user's social relationship with associate users.

4. The computer-implemented method of claim 2, further comprising accessing a data storage that maintains a set of data including the performance data relating to associate users' performance of the Habit step, and wherein the surfacing the plurality of pre-existing options is determined at least partially via the utilization of machine learning techniques over contents of the data storage.

5. The computer-implemented method of claim 4, wherein the utilization of machine learning techniques includes determining at least one of:
the option associated with the fastest onset of self-reported automaticity for the Habit step; and
a minimum viable dosage of the Habit step, based at least on the performance data.

6. The computer-implemented method of claim 1, wherein the data provided by the computing device includes at least one of a time, a date, a location of the computing device, an orientation of the computing device, a rate of motion of the computing device, or a direction of motion for the computing device.

7. The computer-implemented method of claim 1, further comprising receiving user's indication of performing at least one of the Anchor step or Habit step.

8. The computer-implemented method of claim 7, further comprising:
receiving a request to purchase virtual currency from the computing device, the request being inputted by the user via a user interface of the computing device;
crediting the virtual currency to a virtual account of the user based on the purchase; and
crediting the virtual account of the user with virtual currency in response to the receiving indication of the user's performance of the Habit step.

9. The computer-implemented method of claim 7, wherein the Habit step includes a dosage, the method further comprising providing to the user the option to increase the dosage.

10. The computer-implemented method of claim 7, further comprising:
receiving the captured image via a camera of the computing device; and
sharing the captured image with an associate over a network.

11. The computer-implemented method of claim 10, wherein the geographical location of the captured image of the user is geotagged, further comprising:
geotagging geographical location of the computing device associated with the user's indication of performing at least one of the Anchor step or Habit step, wherein determining whether the geotagged geographical location of the captured image of the user is within a predetermined range of the geographical location of the computing device.

12. The computer-implemented method of claim 7, further comprising at least one of the following:
tracking the user's performance of the new habit;
allowing the user to share the new habit with at least one other computing device over a network;
providing a notification to a computing device of an associate user over a network in response to, or in advance of, the detection of the Anchor step;
allowing an associate user to send to the user a message over a network in response to receiving a notification of a detected Anchor step; and
providing a notification to a computing device of an additional user over a network in response to the user's performance of the new habit.

13. The computer-implemented method of claim 1, further comprising:
receiving a designation of a Trigger step to immediately follow the Anchor step, the designation of the Trigger step being inputted via the user interface of the computing device, wherein the designation of the Trigger step is performed by selecting a Trigger step from a group of preexisting triggers displayed by the user interface; and
in response to at least the detecting of the Anchor condition, providing to the user a reminder to perform the Trigger step before performing the Habit step.

14. One or more non-transitory computer-readable media storing computer-executable instructions that upon execution cause one or more processors to perform acts comprising:
receiving a request by a user to display a selectable option relating to the designation of a habit design step, wherein the user has profile information related to the user;
accessing a data storage that maintains a set of data;
generating a subset of data based on a plurality of associate users, wherein each associate user has profile information within a predetermined range of the user's profile information, and wherein the set of data includes a subset of selectable options related to the habit design step;
determining a ranking for each of the subset of selectable options based at least in part on the user's profile information and the subset of data based on the plurality of associate users; and
displaying via the user interface at least one of the ranked options based at least in part on the determined rankings,
wherein the determining a ranking for each of the subset of selectable options is determined at least partially via utilization of machine learning techniques over contents of the data storage.

15. The one or more non-transitory computer-readable media of claim 14, wherein the habit design step is a constituent of a habit design sequence and is at least one of g: a Habit step; an Anchor step; a Trigger step; or an Anchor condition for detecting the occurrence of an Anchor step.

16. The one or more non-transitory computer-readable media of claim 14, wherein the subset of data that is generated based on the plurality of associate users includes performance data relating to the associate users' performance of the Habit step; and wherein the determining a ranking for each of the set of options includes determining the option correlated with the shortest average time taken by the associate users to report having learned the Habit step based at least on the performance data.

17. The one or more non-transitory computer-readable media of claim 16, wherein the habit design step is a Habit step, and wherein the determining a ranking for each of the subset of selectable options further includes determining a minimum viable dosage of the Habit step, based at least on the performance data.

18. The one or more non-transitory computer-readable media of claim 14, wherein the user profile information includes information related to at least one of the user's demographic, the user's participating cohort population, the user's location, the time of day, or the user's social relationship with the associate users.

19. The one or more non-transitory computer-readable media of claim 14, the acts further comprising:
receiving a designation of at least the following: a Habit step, an Anchor step, and an Anchor condition, wherein the detection of the Anchor condition indicates the occurrence of the Anchor step;
detecting the Anchor condition based at least on data provided by the computing device; and
in response to at least the detecting of the Anchor condition, providing a reminder to perform the Habit step.

20. A computer-implemented method for facilitating formation of a new habit, comprising:
receiving a request to display a selectable option relating to the designation of a habit design step, wherein the user has profile information related to the user that includes information related to at least one of the user's demographic, the user's participating cohort population, the user's location, the time of day, or the user's social relationship with a plurality of associate users, and the habit design step includes a quantitative dosage of a Habit step;
accessing a data storage that maintains a set of data including profile information and habit performance information;
generating a subset of data based on a plurality of associate users, wherein each associate user has related profile information within a predetermined range of the profile information related to the user, and wherein the subset of data includes a subset of selectable options related to the habit design step, the subset of data being generated based on performance data relating to the performance of the Habit step by the plurality of associate users;
determining a ranking for each of the subset of selectable options based at least in part on the user profile information and the set of data based on the plurality of associate users, the determining performed based at least partially via the utilization of machine learning techniques over contents of the data storage, the determining including determining the option correlated with the shortest average time taken by previous users reported having learned the Habit step based at least on the performance data, and determining a minimum viable quantitative dosage of the Habit step, based at least on the performance data;
displaying via the user interface at least one of the ranked options based at least in part on the determined rankings;
receiving a designation of at least one of: a Habit step, a Trigger step, an Anchor step, and an Anchor condition, wherein the detection of the Anchor condition indicates the occurrence of the Anchor step;
detecting the Anchor condition based at least on data provided by the computing device; and
in response to at least the detecting of the Anchor condition, providing via the user interface of the computing device a reminder to perform the Trigger step followed by the Habit step.
